(19) United States
(12) Patent Application Publication
(10) Pub. No.: US 2010/0095581 A1
(43) Pub. Date: Apr. 22, 2010

(54) BIODIESEL PRODUCTION UNIT

(75) Inventor: John West, Arab, AL (US)

Correspondence Address: BRADLEY ARANT BOULT CUMMINGS LLP, 200 CLINTON AVE. WEST, SUITE 900, HUNTSVILLE, AL, 35801, US

(73) Assignee: Biodiesel Logic, Inc., Troy, AL (US)

(21) Appl. No.: 12/604,248

(22) Filed: Oct. 22, 2009

Related U.S. Application Data
(60) Provisional application No. 61/107,396, filed on Oct. 22, 2008.

(51) Int. Cl. C10L 1/18; B01J 8/00

(52) U.S. Cl. 44/310; 422/234

(57) ABSTRACT

A biodiesel reactor system includes a reactor recirculation line running from the reactor bottom to a headspace in the top of the reactor. A reactor recirculation pump is in the reactor recirculation line, and a reactor nozzle is positioned in at a reactor recirculation line discharge in the headspace. The reactor nozzle provides back pressure on the reactor recirculation pump to cause a controlled cavitation. The controlled cavitation provides mixing for the various reactants to produce biodiesel fuel.

This application claims priority to U.S. Provisional Patent Application No. 61/107,396, filed Oct. 22, 2008, which is hereby incorporated in its entirety by reference.

### BACKGROUND OF THE INVENTION

a. Field of the Invention

This invention relates to reactors and process equipment used to produce biodiesel.

b. Description of the Related Art

Biodiesel is a fuel which can be produced from commonly available organic oils, such as vegetable oil, cottonseed oil, peanut oil or other organic oils. Once biodiesel is produced it can generally be used in existing diesel engines without any modifications to the engine. The biodiesel can be pumped directly into the fuel tank and used just like regular diesel fuel derived from petroleum. It is also possible to mix biodiesel with standard diesel produced from petroleum in any ratio. So a fuel tank can be filled with 50% biodiesel and 50% petroleum diesel, or it can be 100% biodiesel or 100% petroleum diesel or anywhere in between. This means a person using biodiesel can fill up their tank with petroleum diesel, commonly available at most filling stations, without any concerns. This person can then use biodiesel whenever it is available and convenient.

Biodiesel fuel does have a few varying characteristics as compared to diesel produced from petroleum products. Biodiesel tends to have a higher lubricity. There are also differences which can be found in the viscosity, the flash point, the color and other aspects of the fuel. However, these variations in physical characteristics are not significant enough to require engine modifications for the use of Biodiesel.

Biodiesel is generally made by reacting methanol or some other alcohol with an organic oil in the presence of an alkaline catalyst. The catalyst used is generally some sort of alkaline material, such as sodium hydroxide, potassium hydroxide or other basic substance. The reaction produces biodiesel as well as a glycerol by-product. The biodiesel reaction is called a transesterification reaction. Most organic oils include triglycerides in a significant quantity. This triglyceride is broken down to form fatty acids which react with methanol to produce biodiesel and the by-product glycerol, as seen in the following diagram, where “R” represents an aliphatic compound, and the subscripts on “R” indicate the aliphatic compound can vary.

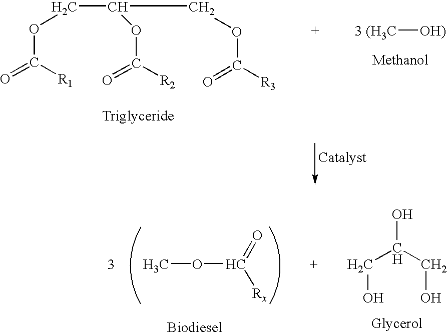

The general process for producing biodiesel may involve cleaning the organic oil to remove solids and other waste material before starting the reaction. Often the organic oil used is waste oil left over from cooking processes, but many other oil sources can also be used. This can include the oil from restaurant's deep fat fryers and other oil collected from restaurants or large scale kitchens. This oil can be cleaned and charged into a reactor where it is heated. A separate alcohol—catalyst solution can be prepared where the catalyst is dissolved in the alcohol. This can involve dissolving solid sodium hydroxide in methanol, although other alcohols can be used such as ethanol or propanol. Other basic catalysts can be used as well. The alcohol/catalyst solution is then charged to the reactor and the reactor is agitated or mixed.

The triglyceride breaks down to fatty acids and then combines with the alcohol to form the biodiesel. The glycerol by-product is formed as the triglyceride breaks down. This reaction continues for a period of time called the reaction time; then all mixing and agitation is stopped and the reaction mass is allowed to split. The glycerol layer will settle and form underneath the biodiesel layer such that there are two layers of material in the reactor. The glycerol layer typically appears physically different than the biodiesel layer, so the split can be located by visual inspection.

The glycerol layer is separated from the biodiesel, and the glycerol can be stored, disposed of, sold as a by-product, or used in some other manner. At this point, the biodiesel fuel is typically purified in one manner or another. For example, the biodiesel can be washed with water, or it can be treated with an ion exchange resin. This washing or treating removes excess glycerol as well as any remaining caustic and free fatty acids from the biodiesel. After the purification process the biodiesel can be used, but it is also possible to flash off any remaining alcohol to further purify the biodiesel fuel. Any alcohol recovered can be saved and used as a raw material in a subsequent batch, and the biodiesel can then be stored and used as a regular fuel for diesel engines.

### BRIEF SUMMARY OF THE INVENTION

A biodiesel reactor system includes a reactor recirculation line running from the reactor bottom to a headspace in the top of the reactor. A reactor recirculation pump is in the reactor recirculation line, and a reactor nozzle is positioned in at a reactor recirculation line discharge in the headspace. The reactor nozzle provides back pressure on the reactor recirculation pump to cause a controlled cavitation. The controlled cavitation provides mixing for the various reactants, which produces biodiesel.

### BRIEF DESCRIPTION OF THE DRAWINGS

FIG. 1 depicts a side view schematic of the reactor with certain internal parts shown.

FIG. 2 is a process flow diagram of one embodiment of equipment used for producing biodiesel fuel.

FIG. 3 is a top perspective view of the reaction nozzle.

FIG. 4 is a bottom perspective view of the reaction nozzle.

FIG. 5 is a process flow diagram of one embodiment of the equipment used for storing and purifying the biodiesel product.

FIG. 6 depicts a side view schematic of the pretreatment tank with certain internal parts shown.

### DETAILED DESCRIPTION

### Biodiesel Reaction

Several basic raw materials are used for producing biodiesel fuel. One is an organic oil. This organic oil can be vegetable oil, but it can also be a variety of other types of oil including cottonseed oil, peanut oil and other oils obtained from a plant. However, oils obtained from animals, such as animal fats, can also be used as the oil feedstock in the biodiesel production process. In this description, the organic oil before any pretreatment is referred to as a raw oil feedstock, the organic oil after a pretreatment step is referred to as a treated oil feedstock, and both the raw and treated oil feedstock is generically referred to as an oil feedstock.

The next raw material is an alcohol. The alcohol reacts with the fatty acids produced during the transesterification reaction. The biodiesel fuel is formed when the alcohol combines with the free fatty acid. Methanol is often the alcohol used, but other alcohols can also be used, such as ethanol, propanol, butanol, or others. Using alcohols with longer carbon chains than methanol, such as ethanol or propanol, may result in lower yields. There also may be cost differences to purchase the different alcohol raw materials. When methanol is used, the alcohol charge can be approximately one fifth of the oil feedstock charge.

A catalyst is also used in the reaction process. The catalyst is a basic material. In one embodiment, solid sodium hydroxide is used as the catalyst. In another embodiment, solid potassium hydroxide is used as the catalyst. Other basic materials can also be used as the catalyst, or different basic materials can be mixed together and used as the catalyst. The amount of catalyst which is charged is determined by titrating the oil feedstock. This titration process to determination the catalyst charge is known in the art. Water is generally considered disadvantageous for the reaction, so aqueous solutions of catalyst are typically avoided. Solid catalysts, such as sodium hydroxide, can be hydrophilic and absorb water from the air. The biodiesel reaction can tolerate small amounts of water, but it is also possible to use desiccants to minimize the amount of water introduced to the reaction system.

Frequently, the oil feedstocks used include impurities because the oils are typically waste material from cooking or other establishments. Recovery of waste oil can be one advantage of the biodiesel production system, because this reduces overall waste and can result in less expensive raw materials. It is also possible to produce biodiesel from fresh, unused oils, if desired. A variety of methods can be used for pre-treating the raw oil feedstock before beginning the reaction. One method is a glycerol wash where glycerol and the raw oil feedstock are mixed together and then allowed to separate into different layers. The glycerol layer is split from the bottom, and the treated oil feedstock on top is used in the reaction. Another pre-treatment method involves a filtration where the raw oil feedstock is run through a filter before the reaction. Other pre-treatment methods may be used as well, such as a water wash or just splitting off excess water charged with the oil feedstock. The pre-treatment methods can be used alone or in combination, and the order is not critical. It is also possible to proceed with the raw oil feedstock without any pre-cleaning. A more detailed description of one pretreatment embodiment is included below.

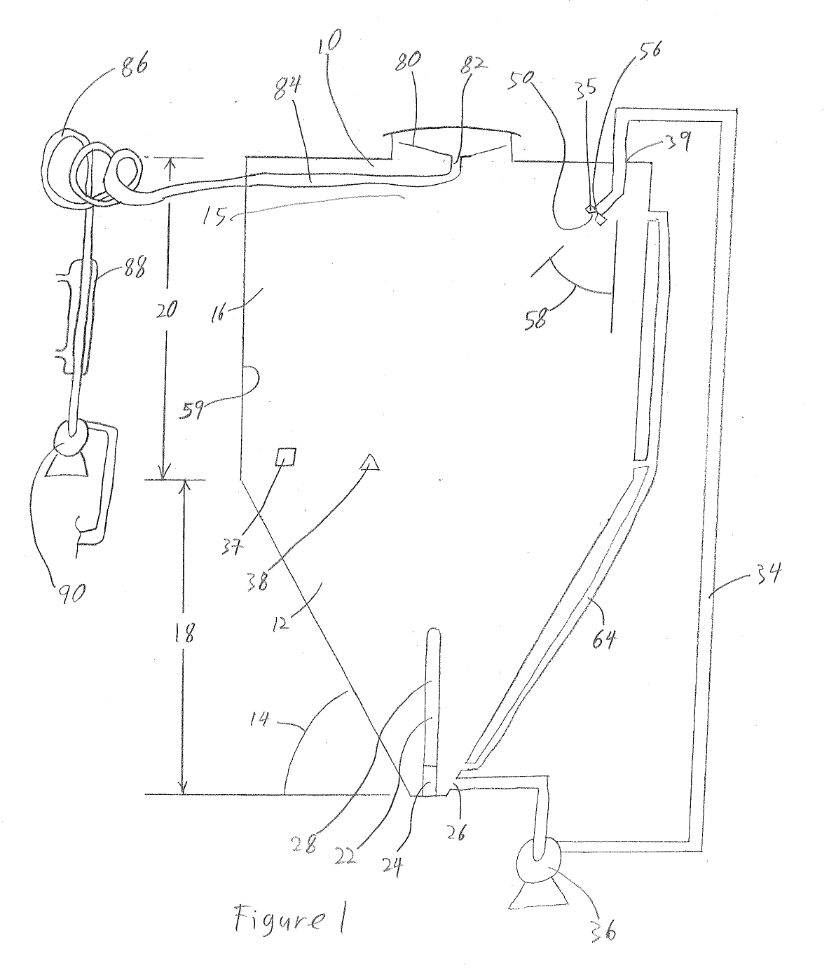

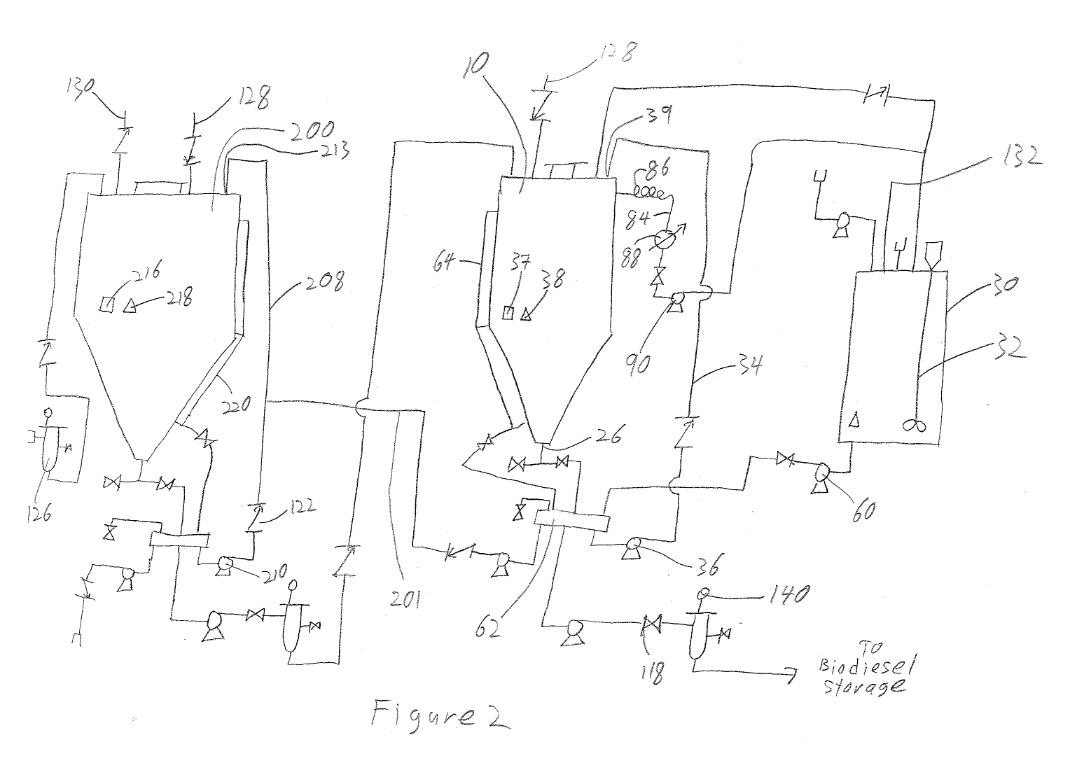

A reactor 10, such as the one shown in FIG. 1 and depicted in the process flow diagram of FIG. 2, can be used to produce biodiesel. It has been found that including a conical section 12 on the bottom of the reactor 10 improves the efficiency of the split and also the overall yield of the biodiesel reaction. This conical section 12 has a cone angle 14 which should be approximately 60°. The reactor 10 also includes a straight section 16 positioned on top of the conical section 12.

The reactor 10 should be constructed such that the conical section 12 contains approximately 35% of the volume of material in the reactor 10. The straight section 16 should contain approximately 65% of the volume of the reactants in the reactor 10 as well as including approximately 20% excess headspace 15 for gas expansion, agitation, and a safety factor. The use of larger headspace volumes in the straight section 16 is acceptable. Therefore, with a 60 degree cone angle 14, a cone height 18 can be approximately 98% of the straight section height 20. The ratio of the reactant volume in the cone section 12 to the reactant volume in the straight section 16 does effect the split and product yield when producing the biodiesel, but variations in the angles and ratios listed above are possible. In one embodiment, the reactor 10 is sized for a particular volume of reaction mass. The reactor size can be set for a consistent volume of oil feedstock, with a corresponding consistent volume of alcohol. In this description, the alcohol referenced is methanol, but it is to be understood that other alcohols could also be used. With methanol, the alcohol charge can be 20% of the oil feedstock charge. Therefore, if the oil feedstock charge is set at 55 gallons, the methanol charge can be 11 gallons, and the reactor 10 can have a volume of approximately 80 gallons. Other oil feedstock charge volumes and reactor volumes are also possible.

The oil feedstock is heated in the reactor 10 by a reactor heater 22. The reactor heater 22 includes a reactor cold section 24 and a reactor heater heating portion 28. The reactor cold section 24 is a part of the heater 22 which is not heated, and the heating portion 28 is a part of the reactor 10 which is heated. The reactor cold section 24 is positioned near the reactor discharge 26 such that material exiting the reactor 10 is not exposed to the heating portion 28 as it exits the reactor 10. The reactor cold section 24 can be approximately 2 inches long, but other lengths are also possible. The reactor discharge 26 is positioned near or at the bottom of the reactor 10. The oil feedstock can be preheated to a temperature of 140° F. (Fahrenheit) by the reactor heater 22 before the alcohol and catalyst are charged to the reactor 10. For more even heating of the oil feedstock, the reactor 10 should be mixed while the oil feedstock is heated. In one embodiment, the reactor 10 is mixed with a reactor recirculation line 34, a reactor recirculation pump 36, and a reactor nozzle 35. The reactor recirculation line 34 extends from the reactor discharge 26 to a reactor top inlet 39, so fluid is removed from the bottom of the reactor 10 and returned to the top of the reactor 10. Other mixing embodiments are also possible, such as an impeller powered by a motor, air jets, or other techniques known in industry. The biodiesel reaction is exothermic, so the reactor heater 22 is turned off before the alcohol—catalyst solution is charged to the reactor 10. The reactor 10 can include a reactor temperature indicator 37 and/or a reactor level switch 38, which can be used with safety interlocks and/or for monitoring process conditions in the reactor 10.

Alcohol and catalyst are charged to a charge vessel 30 where the catalyst is dissolved in the alcohol. The alcohol and catalyst can be agitated to dissolve any solid catalyst used in the alcohol, or to thoroughly mix any liquid catalyst used in the alcohol. The alcohol and catalyst can be charged to the charge vessel 30 before, during, or after the oil feedstock is charged to the reactor 10 and heated, because the alcohol and catalyst do not have to be used as soon as they are prepared. A charge vessel agitator 32 can be used to help dissolve the catalyst in the alcohol.

The alcohol—catalyst solution can be charged from the charge vessel 30 to the reactor recirculation line 34 on the suction side of the reactor recirculation pump 36. The alcohol—catalyst solution can also be charged directly into the reactor 10. If the alcohol—catalyst solution is charged to the reactor recirculation line 34, it can be done while the contents of the reactor 10 are being recirculated through the reactor recirculation line 34. If portions of the reaction mass in the reactor contain over 25% by volume of the alcohol—catalyst solution, soaps can be made. When soaps are made, the reaction yield is decreased, and the soaps may have negative impacts on the split. Therefore, since the alcohol—catalyst solution can be charged into the recirculation line 34, the alcohol—catalyst charge rate should be no more than 25% of the reactor recirculation rate. Controlling the alcohol—catalyst charge rate can help minimize the production of soaps, and therefore improve yield.

### Reactor Mixing

Mixing in the reactor 10 impacts the yield and the split formed between the biodiesel and the glycerol. In one embodiment, recirculation is the primary method of mixing the reactor 10. If the reactor 10 has too much mixing, it can decrease yields in the biodiesel formation. Insufficient mixing in the reactor 10 can unnecessarily lengthen reaction times and can also result in lower overall yields. Different types of mixing, such as high sheer mixing, homogenization, etc. can also impact the reaction yield and the split. Poorer yields tend to result in poorer splits when the glycerol is separated from the biodiesel. The reason different types of mixing affect reaction yields and the split are not known, but extensive experimentation has produced a mixing system with acceptable yields and splits.

The components used to recirculate the reactor 10 can be designed and balanced to achieve the proper level of reactor mixing. The components used to recirculate the reactor 10 include the reactor recirculation pump 36, the reactor recirculation line 34, and the reactor nozzle 35. In one embodiment, the reactor recirculation pump 36 can be a peripheral vane pump with an approximately 12.5 gallon per minute pump rating at 15 feet or water of head back pressure, but other pumps can be used as well. A peripheral vane pump includes a multi-blade rotating element, called the impeller, centrally located in a housing dimensioned to contain the impeller. Liquid is fed into the housing, and centrifugal force pushes the liquid out through a pump outlet. The impeller can have blades on both sides. In one embodiment, the reactor nozzle 35 is specially designed to control the back pressure on the reactor recirculation pump 36 at approximately 46 feet of water of head. This can produce a flow rate of approximately 4.5 gallons per minute in the reactor recirculation line 34 when the reactor 10 is recirculating. The back pressure on the reactor recirculation pump 36 results in a controlled cavitation in the reactor recirculation pump 10, which is a component of the reactor mixing.

The use of a reactor nozzle 35 with a reactor recirculation pump 36 to obtain a controlled cavitation has several advantages. A properly sized reactor nozzle 35 used in tandem with a reactor recirculation pump 36 can provide a simple, inexpensive, relatively low pressure method for using controlled cavitation to mix the oil feedstock with the alcohol and catalyst. The system can be operated at pressures less than 50 PSI (Pounds per Square Inch). Lower operating pressures can result in fewer maintenance issues, and/or allow for components rated for lower pressures in other portions of the system, which can reduce costs. The relatively low pressures and the use of a reactor nozzle 35 for back pressure can provide controlled cavitation with a relatively common, inexpensive reactor recirculation pump 36. Additional, the reactor recirculation pump 36 can operate with relatively low energy usage, and with a relatively small drive. There can be a portion of the reactor recirculation line 34 between the reactor recirculation pump 36 and the reactor nozzle 35 to facilitate the spraying function and location of the reactor nozzle 35 and the location of the reactor recirculation pump 36.

Controlled cavitation can provide good mixing, and back pressure on a pump is one method for obtaining controlled cavitation. The back pressure results in some liquid remaining in the reactor recirculation pump 36 as the pump impeller circulates. The liquid can be forced through the gap between the pump impeller and the pump housing, which can produce a high liquid flow rate and a high shear in this gap. The high liquid flow rate reduces the pressure in the liquid, which causes the relatively volatile alcohol to form bubbles which are then collapsed by the higher pressure in the reactor recirculation pump 36 and the discharge of the reactor recirculation pump 36. The forming and collapsing of bubble is cavitation. The size and type of the reactor recirculation pump 36, the type of alcohol used, and the back pressure produced by the reactor nozzle 35 should be balanced for the proper amount of cavitation. Too much cavitation can produce soap, which lowers yields, and not enough cavitation can increase cycle times and/or decrease yields by not achieving sufficient mixing.

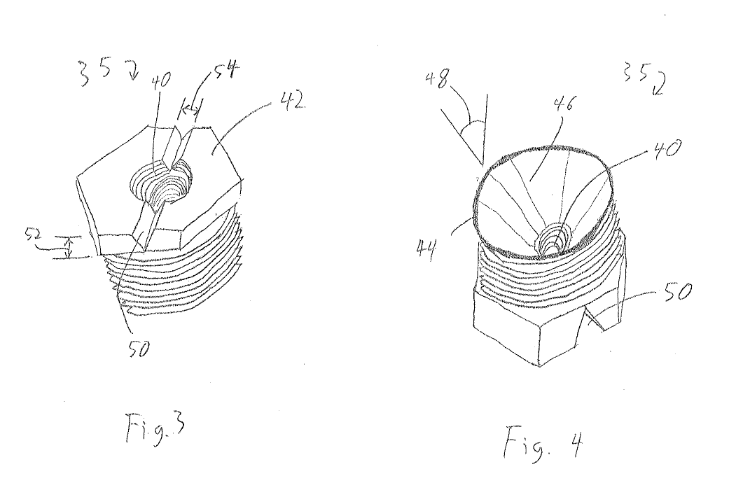

One embodiment of the reactor nozzle 35 is shown in greater detail in FIGS. 3 and 4, with continuing reference to FIGS. 1 and 2. This one embodiment of the reactor nozzle 35 is discussed in more detail, but it is to be understood that alternative designs and dimensions are also possible. The reactor nozzle 35 is made of ¼″ pipe bushing, and this pipe bushing can be made of carbon steel. The pipe bushing can also be made from other materials, such as stainless steel, copper, or anything capable of withstanding the conditions at the reactor nozzle 35. The reactor nozzle 35 includes a primary orifice 40 which is approximately ½″ in diameter. The reactor nozzle 35 also includes a nozzle surface 42 and a bottom surface 44. The primary orifice 40 is counter board from the bottom surface 44 such that the reactor nozzle 35 includes an injection cone 46. The injection cone 46 is counter board from approximately ⅞″ at the bottom surface 44 to approximately ½″ at an injection cone angle 48 of approximately 60°. The reactor nozzle 35 also includes a fan slot 50 in the nozzle surface 42. The fan slot 50 has a fan slot depth 52 of approximately ¼″ and a fan slot width 54 of approximately ⅜″.

The reactor nozzle 35 is mounted at a reactor recirculation line discharge 56 positioned inside the reactor 10, as seen in FIGS. 1 and 2. The reactor recirculation line discharge 56 is any locations where fluids are intended to exit the reactor recirculation line 34. In one embodiment discussed below, the reactor recirculation line discharge 56 is positioned at a reactor recirculation line spray angle 58 of approximately 45°. The reactor recirculation line discharge 56 and reactor recirculation line spray angle 58 are set such that the liquid contents of the reactor recirculation line 34 are sprayed into the reactor 10 such that the spray contacts the surface of the liquid within the reactor 10. The reactor nozzle 35 is positioned in the reactor headspace 15, where the “reactor headspace 15” is defined as the area above the liquid surface in the reactor 10. The reactor 10 also has a reactor sidewall 59, and the reactor nozzle 35 is directed away from reactor sidewall 59 so the reactor nozzle discharge contacts the surface of the liquid in the reactor 10, as opposed to contacting the reactor sidewall 59.

There are different components of the mixing in the reactor 10. The contact of the reactor recirculation line contents with the reaction mass provides one aspect of the agitation and mixing of the reactor 10. The reactor recirculation pump 36 has a controlled cavitation which results from the back pressure maintained by the reactor nozzle 35, and the controlled cavitation is another aspect of the reactor agitation and mixing. The recirculation action, the controlled cavitation in the reactor recirculation pump 36, and the spraying effect from the reactor nozzle 35 all combine to provide an appropriate degree of mixing in the reactor 10. Experimentation has been conducted to determine the recirculation line spray angle 58, the various dimensions of the reactor nozzle 35, and the back pressure needed to maintain the proper controlled cavitation in the reactor recirculation pump 36. The combination of all these elements provides an acceptable degree of agitation, and changing any one factor can impact biodiesel yields and the biodiesel/glycerol split. The balance described here is one embodiment of the current invention, but it is understood that different dimensions and angles can also be combined to achieve an alternate balance with acceptable mixing and reaction results.

If the reactor recirculation rate is approximately 4.5 gallons per minute, the alcohol—catalyst charge rate should not exceed approximately 1.5 gallons a minute in order to control the alcohol—catalyst solution concentration in the oil feedstock at no more than 25% of the total volume. A charge vessel pump 60 can be used for charging the alcohol—catalyst solution into the recirculation line 34. The charge vessel pump 60 can be a diaphragm pump, but other charge techniques can also be used, including centrifugal pumps, peristaltic pumps, or gravity feed. The charge vessel pump 60 can be pneumatically operated, but other power sources can be used as well, such as electricity or gravity.

A reactor recirculation line charge section 62 can facilitate the proper charge rate of the alcohol—catalyst solution. The reactor recirculation line charge section 62 can be an enlarged area in the recirculation line 34 which can provide a lower pressure for the charge vessel pump 60 to overcome when charging the alcohol—catalyst solution. Providing a lower pressure to overcome can improve the control of the charge rate from the charge vessel pump 60. The pressure can also be reduced by positioning the recirculation line charge section 62 on the reactor recirculation pump inlet line instead of on the reactor recirculation pump discharge line. The inlet side of a pump can be referred to as the low pressure side of the pump, and the outlet side of the pump can be referred to as the high pressure side of the pump, because of the relative pressures on opposite sides of a pump. After all of the alcohol—catalyst solution has been charged to the reactor 10, the reactor recirculation pump 36 can continue to recirculate the reactor 10 until the biodiesel reaction is complete. This can be approximately 30 minutes after the completion of the alcohol—catalyst charge, but other times are also possible.

### Separation and Purification

After the biodiesel reaction is complete, the glycerol is split from the biodiesel. The split is performed by stopping the agitation and mixing in the reactor 10. This can be done by verifying the reactor heater 22 is not turned on and turning off the reactor recirculation pump 36. This allows the reaction mass in the reactor 10 to sit still. The biodiesel has a lower specific gravity than the glycerol, and the glycerol will settle to the bottom with the biodiesel rising to the top. A reactor level site glass 64 can be provided for observing the split and also for verifying the level in the reactor 10. The split is usually complete within approximately 30 minutes to three hours after reactor mixing and agitation is stopped. The cone angle 14 of approximately 60° can impact the time necessary for the split to be completed, and it can also affect the quality of the split. When the split is complete, which can be visually observed in the reactor level site glass 64, the glycerol from the bottom of the reactor 10 can be pumped off and stored in a separate storage container. Alternatively, the glycerol layer can be pumped to a pretreatment tank 200, as discussed further below. The glycerol layer can be pumped off using a pump connected to the reactor discharge 26, where the pump used for transferring the glycerol layer can be the reactor recirculation pump 36 or another pump, as the design configuration allows.

The biodiesel remaining in the reactor 10 still has some impurities, including some alcohol. Biodiesel can be used with alcohol present, but recovery of the alcohol provides a purer biodiesel product and can provide additional alcohol for later use, which can save on product costs. There are several ways to further purify the biodiesel, and these techniques can be used alone or in combination. In one embodiment, the ethanol is recovered from the biodiesel after the glycerol layer is separated. The reactor 10 includes a catch basin 80 positioned in the reactor headspace 15 near the top of the reactor 10. The catch basin 80 has an upside down conical shape, where the point of the conical shape is the lowest point of the catch basin 80. Any liquid falling into the catch basin 80 is drawn by gravity to the point of the conical shape, which can be at or near the center of the catch basin 80. There is a catch basin drain 82 at the lowest portion of the catch basin 80, and collected liquid can flow out of the catch basin 80 through the catch basin drain 82.

Additional components are connected to the catch basin 80 to facilitate the collection and transfer of liquid. An alcohol drain line 84 is connected to the catch basin drain 82 such that liquid flows through the catch basin drain 82 into the alcohol drain line 84. The alcohol drain line 84 penetrates the reactor 10, so at least a portion of the alcohol drain line 84 is positioned external to the reactor 10. The alcohol drain line 84 can include a coiled section 86, where liquids can collect in the coils to form a trap or barrier to gas flow. The coiled section 86 could have other shapes, such as one or more goose neck shapes, a “W” shape, or even a simple straight section of line. A heat exchanger 88 can be connected to the alcohol drain line 84 as well. The discharge of the heat exchanger 88 can be directed to a vessel to store alcohol, which can be the charge vessel 30 or some other vessel. There can also be a vacuum pump 90 connected in the alcohol drain line 84 either upstream or downstream from the heat exchanger 88. Several different designs could also be used to collect alcohol from the reactor 10.

One embodiment for recovering alcohol from the biodiesel is discussed below, but other embodiments are also possible. The biodiesel is recirculated in the reactor recirculation line 34 after the glycerol split to collect excess alcohol. The biodiesel can also be heated to help the alcohol vaporize from the biodiesel, and a temperature of approximately 185 degrees Fahrenheit can be used. A slight vacuum can also be pulled in the reactor 10 to help vaporize alcohol, and this vacuum can be drawn by the vacuum pump 90. The vacuum can be about four (4) inches of water, and this vacuum can be controlled by including a vacuum regulator 128 on the reactor 10 set at the desired amount of vacuum. The above conditions are beneficial for recovering methanol, but other conditions may be more beneficial if different alcohols are used. The increased temperature and decreased pressure in the reactor increases the amount of alcohol vaporizing, and the spraying of the recirculating liquid onto the surface of the reaction mass also helps to vaporize the alcohol.

The catch basin 80 can be positioned underneath an uninsulated portion of the reactor 10, so vaporized alcohol can cool when contacting the uninsulated reactor. This uninsulated portion can be a manway for easy access to the catch basin 80, but the uninsulated portion does not have to be at a manway. The entire reactor 10 can be uninsulated, and in one embodiment the uninsulated area over the catch basin 80 can be a thinner material than most of the reactor 10, to facilitate cooling. The cooler surface of the reactor 10 over the catch basin 80 condenses the alcohol, which eventually forms drops and falls into the catch basin 80. The catch basin 80 catches the condensed drops of alcohol, and directs the liquid flow through the catch basin drain 82 to the alcohol drain line 84 and eventually to a storage vessel, such as the charge vessel 30. Pulling vacuum through the alcohol drain line can induce a flow into the alcohol drain line 84, which may further facilitate the collection of alcohol from the reactor 10. Liquid condensed alcohol can be pulled into the vacuum pump 90 and pumped by the vacuum pump 90 to the charge vessel 30. The shape of the uninsulated portion of the reactor 10 can include structures to facilitate drop formation and dripping into the catch basin 80, but shapes which do not facilitate drop formation and dripping into the catch basin 80 can also be effective. The collected alcohol can then be used in the production of a subsequent batch of biodiesel.

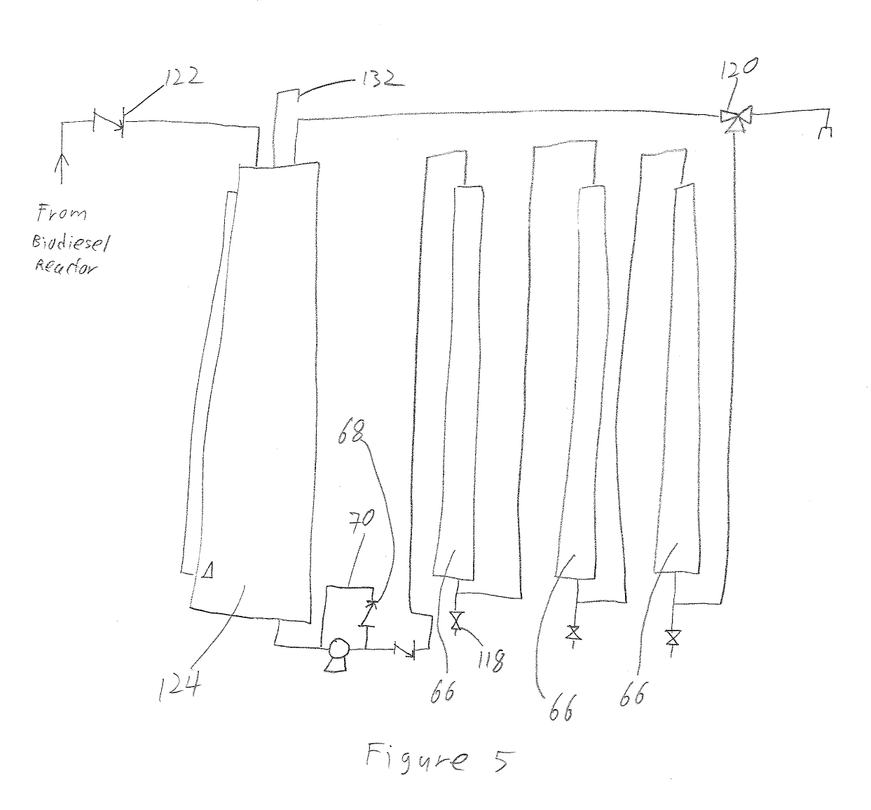

After the glycerol layer and alcohol have been removed from the biodiesel, there are still some remaining impurities in the biodiesel which can be removed. A water wash can be used for this removal, but it is also possible to use an ion exchange resin for purifying the biodiesel. The ion exchange resin can be stored in a resin column 66, as seen in FIG. 5, with continuing reference to FIGS. 1 and 2. The ion exchange resin can be a resin such as that sold under the trademark of AMBERLITE® BD10DRY®, but other types of resin can also be used. The ion exchange resin can be held in the resin column 66 using a mesh in the bottom of the resin column 66. The amount of ion exchange resin can be based on the planned oil feedstock batch size, and manufacture recommendations can be used to determine the quantity of ion exchange resin used. The mesh can be supported on a grate and secured in place with a bracket such that the mesh is sandwiched between the grate and the bracket. The biodiesel should not be charged through the resin column 66 at too fast a rate, or the ion exchange resin may not complete the purification process. Ion exchange resins often include specific recommendations for the rate at which material can be passed through the resin, and following these recommendations can improve results.

The biodiesel production unit can be designed to control the charge rate through the resin column 66. One embodiment for controlling the charge rate is to provide a bypass line 70 with a bypass spring loaded check valve 68 on the discharge side of the reactor recirculation pump 36. The bypass line 70 can be directed from the high pressure side of a pump to the low pressure side of a pump, or it can be directed from the high pressure side of a pump back to a storage vessel. Other flow control measures can also be used, including a needle valve, an orifice in the line, or control valves.

The biodiesel product can be passed through the ion exchange resin at several places in the process. The biodiesel can be transferred from the reactor 10 to a biodiesel storage tank 124 to make room in the reactor 10 for the next batch of biodiesel. The biodiesel can be passed through the resin column 66 between the reactor 10 and the biodiesel storage tank 124. Alternatively, the biodiesel can be passed through the resin column 66 after being transferred from the reactor 10 to the biodiesel storage tank 124. This can be done by recirculating the biodiesel through the resin column 66 and back to the biodiesel storage tank 124, or it can be done by passing the biodiesel through the resin column 66 when the biodiesel storage tank 124 contents are transferred to another container for shipment or use.

An optical sensor can be positioned next to the reactor level site glass 64 to detect when the reactor 10 is empty. This allows a computer or other controlling device to automatically turn off the reactor recirculation pump 36 when the reactor 10 is empty, and thereby reduce hazards caused by running a pump with no fluids present. Other devices can be used to detect when the reactor is empty as well, such as level indicators or weight cells.

### Pretreatment

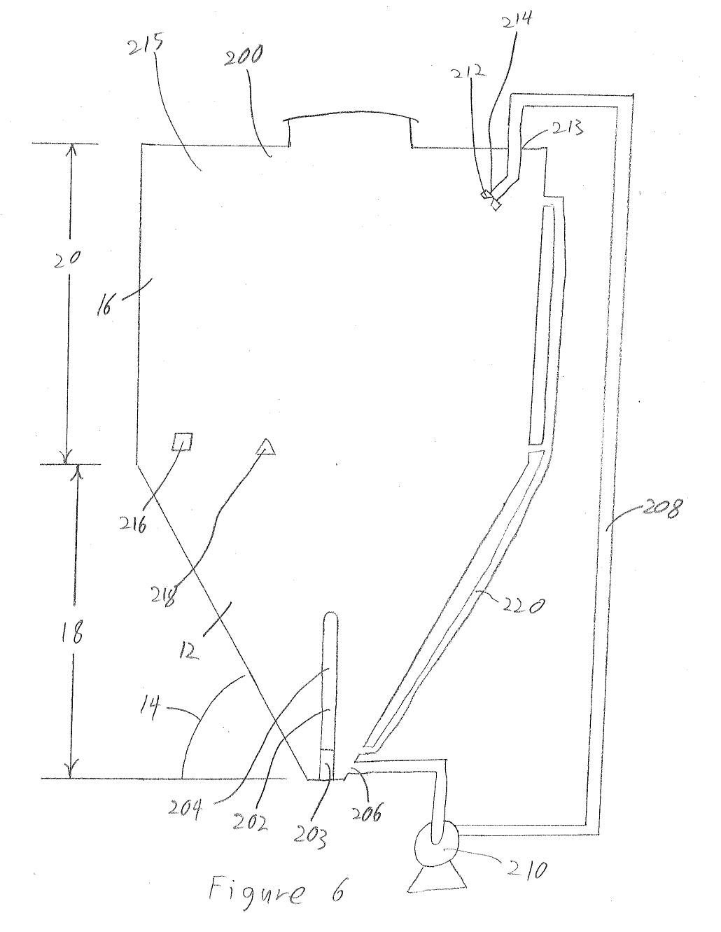

The oil feedstock can be pretreated before conversion to biodiesel. Including a pretreatment system with the reactor 10 can simplify the pretreatment process. In one embodiment, a pretreatment tank 200 is included with the biodiesel reactor system, as shown in FIGS. 6 and 1, with continuing reference to FIG. 2. A line 201 connects the pretreatment tank 200 to the reactor 10, where the line 201 can contain liquids for a fluid transfer. A pump can be connected in the line 201 for the transfer as well. In general, the pretreatment tank 200 can use the same design, materials, shape, and dimensions as the reactor 10. This can simplify construction, because fewer vessel designs are needed. Also, the pretreatment process can begin converting some oil feedstock to biodiesel, and the reactor 10 design facilitates this conversion. The pretreatment process also can clean undesirable impurities from the oil feedstock.

The pretreatment tank 200 can have many features the same as in the reactor 10. For example, the conical section 12, the cone angle 14, the straight section 16, the cone height 18, and the straight section height 20 can all be the same in the pretreatment tank 200 as in the reactor 10. A pretreatment heater 202 can have the same design as the reactor heater 22, with a pretreatment cold section 203 and a pretreatment heater heating portion 204 the same as the reactor cold section 24 and the reactor heater heating portion 28. The recirculation system can also have the same design, where a pretreatment discharge 206, a pretreatment recirculation line 208, a pretreatment recirculation pump 210, a pretreatment nozzle 212, a pretreatment top inlet 213, a pretreatment headspace 215, and a pretreatment recirculation line discharge 214 are all the same as the reactor discharge 26, the reactor recirculation line 34, the reactor recirculation pump 36, the reactor nozzle 35, the reactor top inlet 39, the reactor headspace 15, and the reactor recirculation line discharge 62 respectively. The design elements, positioning, and location of the pretreatment nozzle 212 can be the same as that described for the reactor nozzle 35 above. Additionally, a pretreatment temperature indicator 216, a pretreatment level switch 218, and a pretreatment level sight glass 220 can be the same as the reactor temperature indicator 37, the reactor level switch 38, and the reactor level sight glass 64 as described above, respectively. It is also possible for the pretreatment tank 200 to have a different design than the reactor 10.

The pretreatment tank 200 can differ from the reactor 10 in the alcohol recovery system. In some embodiments, no alcohol is recovered from the pretreatment tank 200, so the pretreatment tank may not have comparable components to the catch basin 80, the catch basin drain 82, the alcohol drain line 84, the coiled section 86, the heat exchanger 88, and the vacuum pump 90 used with the reactor 10.

In the pretreatment step, raw oil feedstock is treated and converted to treated oil feedstock. Raw oil feedstock is charged to the pretreatment tank 200, and the glycerol split from the bottom of the reactor 10 is also charged to the pretreatment tank 200. The glycerol contains alcohol and catalyst impurities, so these impurities are available to react with the raw oil feedstock, similar to the biodiesel reaction in the reactor 10. The temperature of the raw oil feedstock and glycerol can be elevated somewhat, such as above 100 degrees Fahrenheit, but a wide variety of starting temperatures are possible. The glycerol and raw oil feedstock can be charged in any order, but in one embodiment the glycerol is charged into the pretreatment recirculation line 208 while the raw oil feedstock is being recirculated within the pretreatment tank 200.

The raw oil feedstock and the glycerol are recirculated in the pretreatment tank 200 the same as described for the reactor 10. The glycerol contains some alcohol and catalyst, but not enough to completely convert the raw oil feedstock to biodiesel, but some of the raw oil feedstock may be converted to biodiesel. This recovers the alcohol and catalyst that otherwise remains as an impurity in the glycerol, which can improve overall costs. Also, some of the “globs” and thicker portions of the raw oil feedstock seem to become less viscous and go into solution during this pretreatment step. This can improve the overall oil feedstock conversion ratio, because untreated “globs” can be filtered out before conversion to biodiesel. The “globs” may thin and go into solution in the pretreatment process because of partial reaction, or because of changes in the solvent properties of the oil feedstock, or perhaps for other reasons. The pretreatment process may also shorten cycle times for the biodiesel reaction step, and the pretreatment can be performed during the biodiesel reaction, so there may be no delay to the overall process.

The pretreatment process can include one or more of a reaction process, a split process, and a filtration process in essentially any combination. The reaction process is performed by combining the glycerol from the reactor 10 split with the raw oil feedstock, and recirculating in the pretreatment recirculation line 208. The split process can follow the reaction process, where the pretreatment tank 200 is not heated or recirculated, and the glycerol and oil feedstock are allowed to split. The lower glycerol layer can then be split off and stored, sold, disposed of, or used in any way desired. Many impurities in the raw oil feedstock may remain in the glycerol, because the glycerol is a more polar compound and is heavier than the oil feedstock. This includes compounds such as water, which tend to remain in the glycerol layer. The filtration process can be completed before or during the transfer from the pretreatment tank 200 to the reactor 10, and can be performed with a filter. The filtration process can also be performed when the raw oil feedstock is charged to the pretreatment tank 200. The filtration process can remove solid contaminates from the oil feedstock.

Different pretreatment processes can also be used. For example, a water wash can be used, or multiple filtrations can be performed. These steps may be added to the steps described above if desired, or even used in place of the steps described above. After the pretreatment process, the raw oil feedstock has been changed to treated oil feedstock, which can be charged to the reactor 10. It is also possible to charge raw oil feedstock directly to the reactor 10, and completely skip the pretreatment process. However, the pretreatment process can improve yields and also generally improve operations.

### Equipment

Several items in FIGS. 2 and 5 can be utilized to facilitate the biodiesel production process, with continuing reference to FIGS. 1 and 6. Several symbols are used repeatedly, and reference will be made here to those symbols such that they can be understood by the reader. The process flow diagram includes manual valves 118, three way valves 120, check valves 122 which prevent backflow and only allow fluid to flow in one direction, and bag filters 126. There is also a vacuum regulator 128 which can be set at approximately 1½ pounds per square inch and a pressure regulator 130 which can also be set at approximately 1½ pounds per square inch, although other settings are also possible.

The vacuum and pressure regulators 128, 130 can be used to control the pressure in the headspace above liquids in the reactor 10 and in the pretreatment tank 200, as well as any other vessels as desired. An open vent 132 can also be utilized, such as is shown on the charge vessel 30. Couplings can be used at the end of lines when frequent connections are needed, and plugs can be used at the end of lines when frequent connections are not needed. Plugs can include such things as caps, blind flanges, or even welds. A pressure indicator 140 can be utilized to measure pressure at almost any location in the process.

It should be noted that many different configurations are possible which would achieve similar results. Processes can be highly automated or they can be more manual, as desired. Different size lines can be used and different devices can accomplish similar results. For example, the level of a tank can be determined by a see through line which has a connection near the top and near the bottom of the tank. It is also possible to measure the level of the tank with level indicators which electronically measure the tank. The level of a tank can also be determined with weigh cells, where the weight of the material in the tank is generally know, and a wide variety of other methods can also be used. This is true throughout this disclosure. In the chemical processing industry it should be understood that a wide variety of different configurations can be utilized which will accomplish similar results to those shown. However, certain components, as has been mentioned, have been specifically designed and optimized for biodiesel production, and it has generally been found that these components, elements, dimensions, angles, etc., have an impact on the cycle time, yield and quality of the biodiesel fuel produced.

The combination of the reactor with the conical section and the recirculation process for mixing are the result of experimentation. Use of this equipment can provide good biodiesel yields, relatively clean biodiesel/glycerol splits, and relatively short cycle times in the biodiesel production process.

While the invention has been described with respect to a limited number of embodiments, those skilled in the art, having benefit of this disclosure, will appreciate that other embodiments can be devised which do not depart from the scope of the invention as disclosed here. Accordingly, the scope of the invention should be limited only by the attached claims.

I claim:

1. A biodiesel reactor system comprising:
a reactor having a reactor bottom discharge and a reactor top inlet;
a reactor recirculation line extending from the reactor bottom discharge to the reactor top inlet, where the reactor recirculation line includes a reactor recirculation line discharge;
a reactor recirculation pump connected to the reactor recirculation line; and
a reactor nozzle connected to the reactor recirculation line discharge, where the reactor nozzle provides backpressure to the reactor recirculation pump such that cavitation occurs in the reactor recirculation pump.

2. The biodiesel reactor system of claim 1 where the reactor recirculation pump is a peripheral vane pump.

3. The biodiesel reactor system of claim 1 where backpressure to the reactor recirculation pump is less than 50 pounds per square inch.

4. The biodiesel reactor system of claim 1 where the reactor further comprises:
a reactor headspace;
a catch basin positioned in the reactor headspace;
an alcohol drain line positioned at least partially exterior to the reactor; and
a heat exchanger connected to the alcohol drain line, and where the catch basin includes a catch basin drain connected to the alcohol drain line so liquid collected in the catch basin drains by gravity into the alcohol drain line.

5. The biodiesel reactor system of claim 1 further comprising:
a pretreatment tank including a pretreatment bottom outlet and a pretreatment top inlet;
a line connecting the pretreatment tank to the biodiesel reactor;
a pretreatment recirculation line extending from the pretreatment bottom outlet to the pretreatment top inlet, where the pretreatment recirculation line includes a pretreatment recirculation line discharge;
a pretreatment recirculation pump connected to the pretreatment recirculation line; and
a pretreatment nozzle connected to the pretreatment recirculation line discharge, where the pretreatment nozzle provides backpressure to the pretreatment recirculation pump such that cavitation occurs in the pretreatment recirculation pump.

6. The biodiesel reactor system of claim 1 where the reactor further comprises a reactor headspace, and the reactor nozzle is positioned in the reactor headspace.

7. The biodiesel reactor system of claim 6 where the reactor includes a reactor sidewall, and the reactor nozzle is directed away from the reactor sidewall.

8. A biodiesel reactor system comprising:
a reactor;
a pretreatment tank including a pretreatment bottom outlet and a pretreatment top inlet;
a line connecting the reactor to the pretreatment tank;
a pretreatment recirculation line extending from the pretreatment bottom outlet to the pretreatment top inlet, where the pretreatment recirculation line includes a pretreatment recirculation line discharge;
a pretreatment recirculation pump connected to the pretreatment recirculation line; and
a pretreatment nozzle connected to the pretreatment recirculation line discharge, where the pretreatment nozzle provides backpressure to the pretreatment recirculation pump such that cavitation occurs in the pretreatment recirculation pump.

9. The biodiesel reactor system of claim 8 where the pretreatment recirculation pump is a peripheral vane pump.

10. The biodiesel reactor system of claim 9 where the pretreatment recirculation pump has a discharge pressure of less than 50 pounds per square inch.

11. The biodiesel reactor system of claim 10 where the pretreatment tank further comprises a pretreatment tank sidewall, and the nozzle is directed away from the pretreatment tank sidewall.

12. A biodiesel reactor system comprising;
a reactor having a headspace;
a catch basin positioned in the headspace, where the catch basin includes a catch basin drain;
an alcohol drain line connected to the catch basin drain, where the alcohol drain line is at least partially positioned external to the reactor vessel; and
a heat exchanger connected to the alcohol drain line.

13. The biodiesel reactor system of claim 12 where:
the reactor includes a reactor bottom outlet, a reactor top inlet, a reactor headspace, and a reactor sidewall, the biodiesel reactor system further comprising;
a reactor recirculation line extending from the reactor bottom outlet through the reactor top inlet, where the reactor recirculation line includes a reactor recirculation line discharge;
a reactor recirculation pump positioned in the reactor recirculation line a reactor nozzle connected to the reactor recirculation line discharge, where the reactor nozzle provides backpressure to the reactor recirculation pump such that cavitation occurs in the reactor recirculation pump, and where the reactor nozzle is positioned in the reactor headspace and directed away from the reactor sidewall.

14. The biodiesel reactor of claim 13 further comprising:
a pretreatment tank including a pretreatment bottom outlet, a pretreatment top inlet, a pretreatment headspace, and a pretreatment sidewall;
a line connecting the reactor to the pretreatment tank;
a pretreatment recirculation line extending from the pretreatment bottom outlet to the pretreatment top inlet, where the pretreatment recirculation line includes a pretreatment recirculation line discharge;
a pretreatment recirculation pump in the pretreatment recirculation line; and
a pretreatment nozzle connected to the pretreatment recirculation line discharge, where the pretreatment nozzle provides backpressure to the pretreatment recirculation pump such that cavitation occurs in the pretreatment recirculation pump, and where the pretreatment nozzle is positioned in the pretreatment headspace and directed away from the pretreatment sidewall

15. A method of producing biodiesel comprising:
(a) charging an oil feedstock to a reactor;
(b) recirculating the oil feedstock in the reactor using a reactor recirculation line and a reactor recirculation pump such that the reactor recirculation pump cavitates while recirculating;
(c) charging a catalyst and an alcohol to the reactor;
(d) allowing the oil feedstock to split after step (c); and
(e) splitting a glycerol layer from a biodiesel layer formed during step (c).

16. The method of claim 15 where the reactor recirculation line includes a low pressure side and a high pressure side on opposite sides of the reactor recirculation pump, and the catalyst and alcohol are charged on the low pressure side of the reactor recirculation line.

17. The method of claim 15 further comprising:
(f) spraying the oil feedstock onto a reactor liquid surface through a nozzle during step (b).

18. The method of claim 15 further comprising:
(g) recirculating the biodiesel layer after step (e);
(h) heating the biodiesel layer while recirculating; and
(i) catching alcohol in a catch basin positioned in a reactor headspace within the reactor.

19. The method of claim 15 further comprising:
(j) charging an oil feedstock to a pretreatment tank;
(k) charging the glycerol from step (e) to the pretreatment tank;
(l) recycling the oil feedstock and glycerol in the pretreatment tank through a pretreatment recirculation line and a pretreatment recirculation pump such that the recirculation pump cavitates;
(m) allowing the oil feedstock to split from the glycerol after step (I); and
(n) splitting the oil feedstock from the glycerol after step (m).

20. The method of claim 19 further comprising charging the oil feedstock from step (n) into the reactor in step (a).
